(19) United States
(12) Patent Application Publication
(10) Pub. No.: US 2012/0140521 A1
(43) Pub. Date: Jun. 7, 2012

(54) FLAT PANEL DISPLAY

(76) Inventors: Lien-Te Kao, New Taipei City (TW); Hung-Yu Pan, New Taipei City (TW); Chi-Yeh Lu, New Taipei City (TW)

(21) Appl. No.: 13/160,478

(22) Filed: Jun. 14, 2011

(30) Foreign Application Priority Data
Dec. 3, 2010 (TW) 099142066

(51) Int. Cl. F21V 7/04

(52) U.S. Cl. 362/623

(57) ABSTRACT

In a flat panel display, a reflector and a light guide plate are enlarged and a support section is formed on the light guide plate. A support component made of Methylsilanol Mannuronate with high stiffness is configured onto the support section and utilized for supporting a cell. After optical films are configured on the light guide plate, and between the support component, the cell is then placed on the support component. Finally, a top frame and two covers are assembled to complete the assembly of the flat panel display.

### BACKGROUND OF THE INVENTION

1. Field of the Invention

The invention relates to a flat panel display, and more particularly, to a flat panel display without using plastic frame.

2. Description of the Prior Art

Conventional flat panel displays need frame structure to protect the backlight module and each components of the panel, such as a light emitting diodes source, a light guide plate, optical films, prism film, cell . . . etc. After each component is assembled together in the frame structure to be a panel module in panel factory, the panel module is then transported to a system factory for assembling with outermost housings, generally including a top housing and a bottom housing.

Besides the frame structure as a main support of the panel module, a plastic frame is further configured in the frame structure, where the reflector, the light guide plate and the light source, and the optical films are placed in the inner space of the plastic frame to be assembled to the frame structure. The cell is supported by the plastic frame, usually coated with Methylsilanol Mannuronate layer and avoiding the probability of damaging the surface of the cell as the plastic frame is in contact with the cell. Above the frame structure and the cell, a top frame in added thereto for fixing and protecting the cell. Finally, the top housing and the bottom housing are assembled to the panel module as ornamental components. Such way of assembling, however, needs higher cost of design and components, also adding up the cost for package and transport.

### SUMMARY OF THE INVENTION

The invention provides a flat panel display. The flat panel display includes a frame structure, a reflector and a light guide plate stacking on the frame structure in order, a support component configured on the light guide plate, a cell placed on the support component, and a top frame mounted to the cell and the frame structure for fixing the cell.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram showing a reflector and a light guide plate configured in a frame structure of a first embodiment of a flat panel display according to the invention.

FIG. 2 is a schematic diagram showing a support component configured on the light guide plate according to the first embodiment.

FIG. 3 is a schematic diagram of a first embodiment of the support component configured on the light guide plate.

FIG. 4 is a schematic diagram of optical films configured on the light guide plate and between the support component according to the first embodiment of the flat panel display.

FIG. 5 is a schematic diagram showing that the cell of the flat panel display is supported by and placed on the support component according to the first embodiment of the flat panel display.

FIG. 6 is a schematic diagram of a top frame adding to the cell to be a panel module according to the first embodiment of the flat panel display.

FIG. 7 is a schematic diagram showing the first embodiment of the flat panel display.

FIG. 8 is a schematic diagram of a second embodiment of the flat panel display.

FIG. 9 is a schematic diagram of a second embodiment of the support component configured on the light guide plate.

FIG. 10 is a schematic diagram of a third embodiment of the support component configured on the light guide plate.

### DETAILED DESCRIPTION

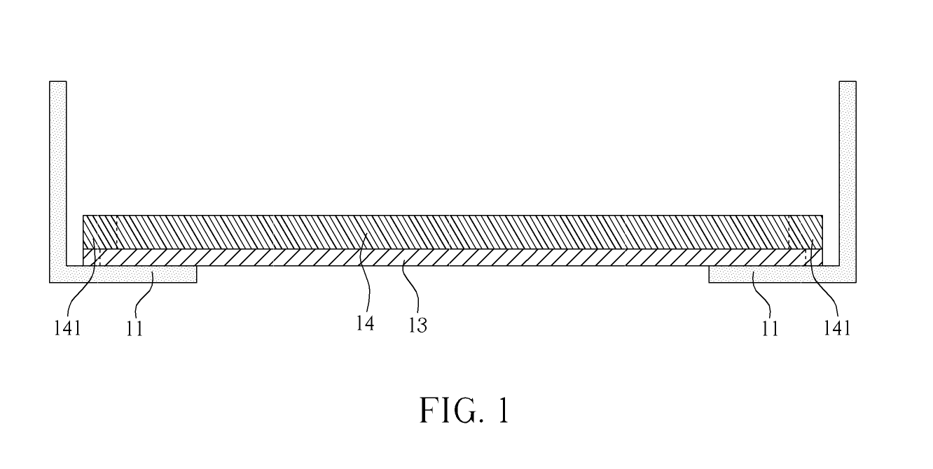

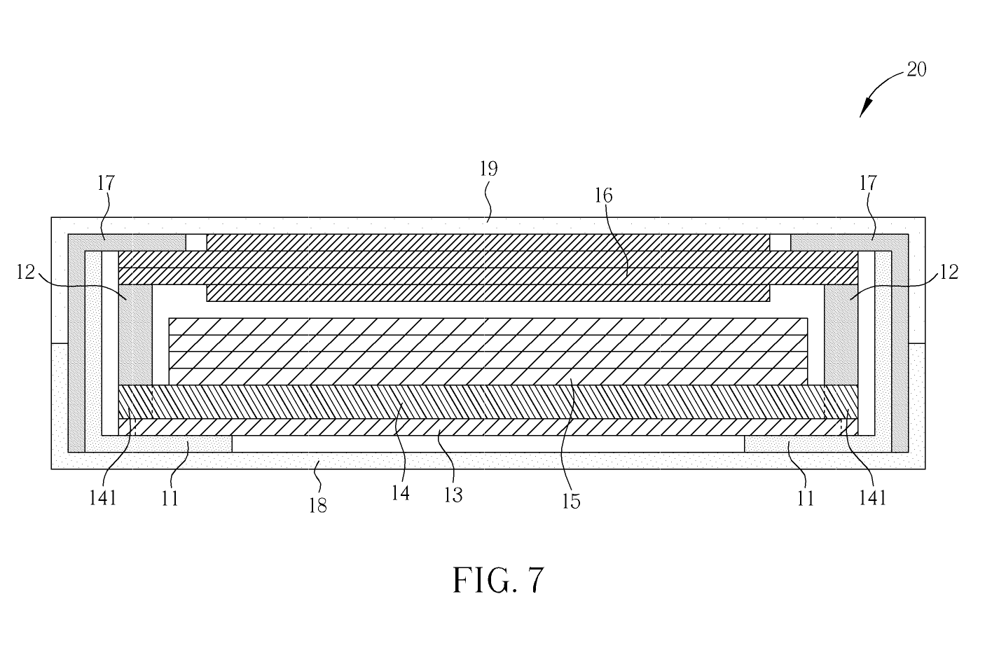

In the embodiments of this invention, a Methylsilanol Mannuronate component with high stiffness is in replace of conventional plastic frame for supporting the cell. Please refer to FIG. 1 and FIG. 7. FIG. 1 is a schematic diagram showing a reflector 13 and a light guide plate 14 configured in a frame structure 11 of a first embodiment of a flat panel display according to the invention. FIG. 7 is a schematic diagram showing cross sectional view of a first embodiment of a flat panel display 20. The flat panel display 20 includes a frame structure 11, a reflector 13, a light guide plate 14, a support component 12, a plurality of optical films 15, a cell 16, a top frame 17, a first housing 18, and a second housing 19. As shown in FIG. 1, the reflector 13 and the light guide plate stack on the frame structure 11 in order, which in this invention, the size of the light guide plate 14 is enlarged to have a support section 141 at the perimeter for supporting the support component 12. The reflector 13 under the light guide plate 14 is also enlarged accordingly.

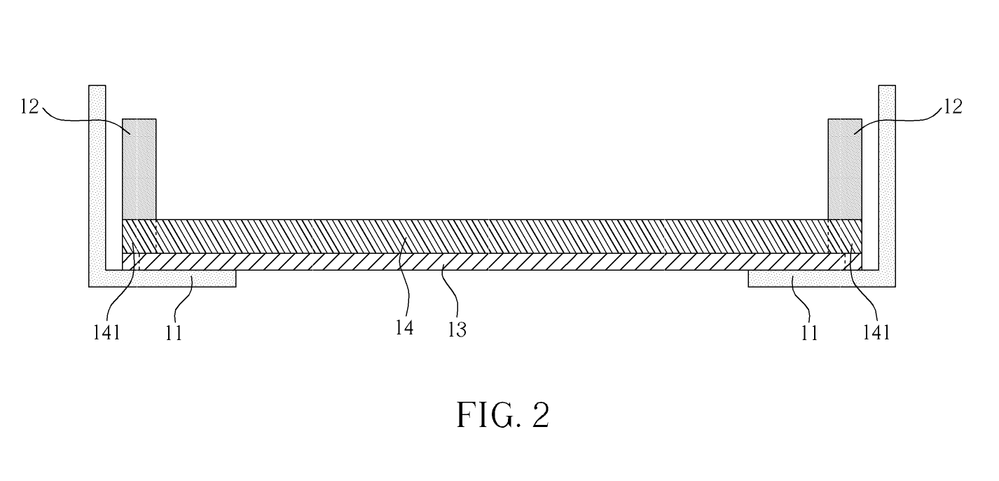

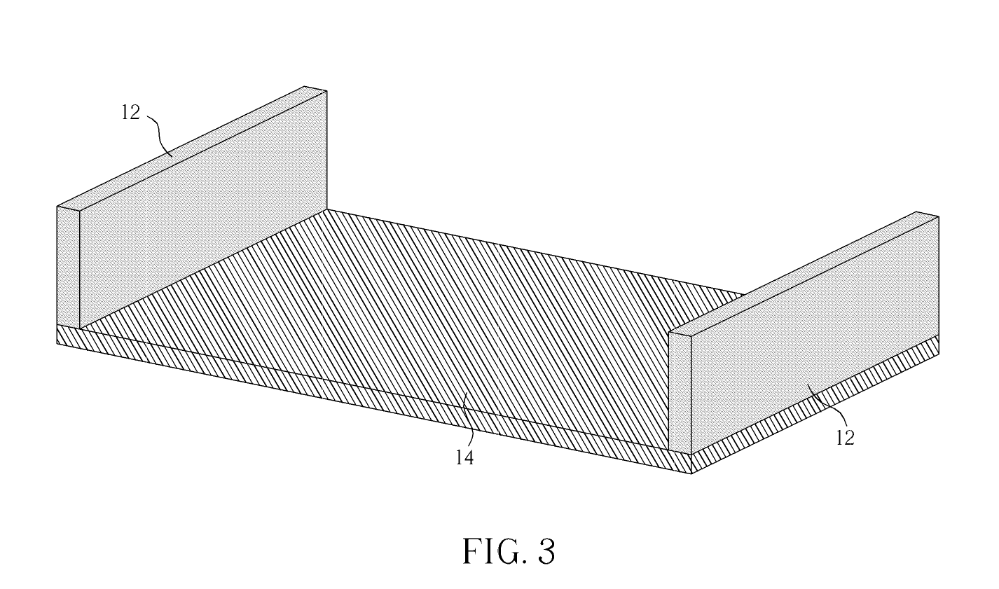

Please refer to FIG. 2. The support component 12 is configured on the support section 141 of the light guide plate 14. Practically, the support component 12 can be made of Methylsilanol Mannuronate, and preferably with stiffness over 70% as a suitable support material. Due to the high stiffness, the support component 12 bears capable stiffness for supporting the cell 16 in the following assembling. Also because of the characteristic of Methylsilanol Mannuronate of the support component 12, the surface of the support component 12 will not scratch or damage the cell 16 as it supports the cell 16. Additionally, when configured on the support section 141 of the light guide plate 14, the support component 12 is assembled to the light guide plate 14 via glue or thermoforming. FIG. 3 shows a schematic diagram of a first embodiment of the support component 12 configured on the light guide plate 14 according to the invention. As can be seen in FIG. 3, the support component 12 is configured at two opposite sides of the light guide plate 14, which in this embodiment, the short sides of the light guide plate 14, for providing support for the cell 16. As two rectangular pieces, the support component 12 requires relatively low cost to manufacture and assemble.

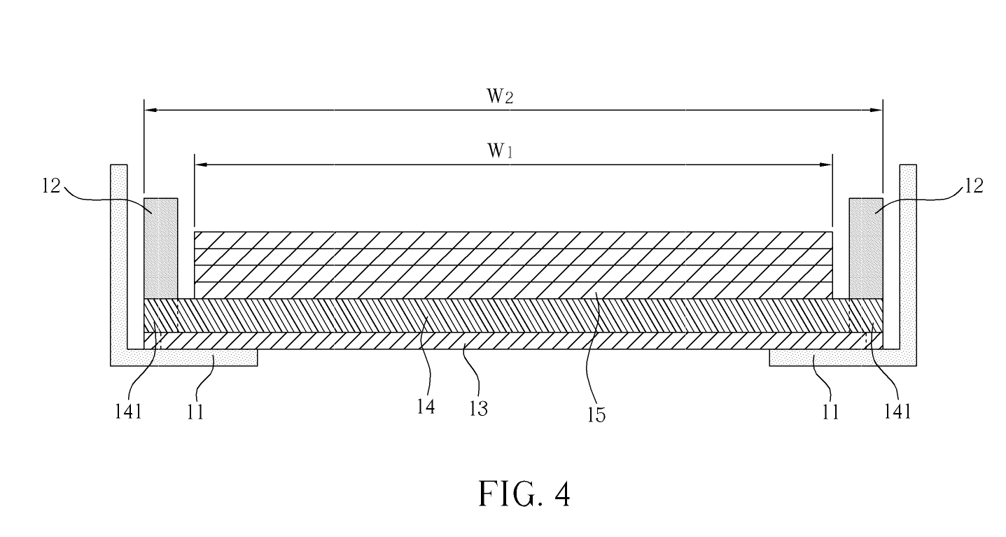

Please refer to FIG. 4. After the support component 12 is assembled to the sides of the light guide plate 14, the plurality of optical films 15 of the flat panel display 20 is then stacked on the light guide plate 14. In this embodiment, the light guide plate 14 and the reflector 13 are enlarged to have larger size than the optical films 15 and the display plane of the cell 16 thereon. FIG. 4 shows that the width of the reflector 13 and the light guide plate 14 along the horizontal direction is W₂, while the width of the optical films along the horizontal direction is W₁, and W₂ is larger than W₁. The part of the light guide plate 14 that is larger than the optical films 15 is the support section 141 to support the support component 12. Since the size of the optical films 15 is smaller than that of the light guide plate 14 the optical films 15 will not cover the support section 141, the optical films 15 are placed between the support component 12 when stacking on the light guide plate 14.

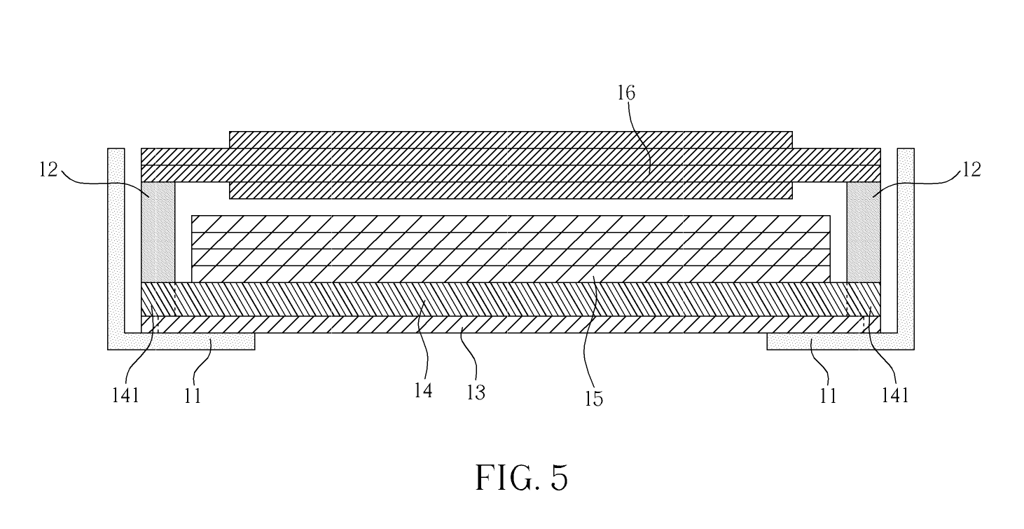

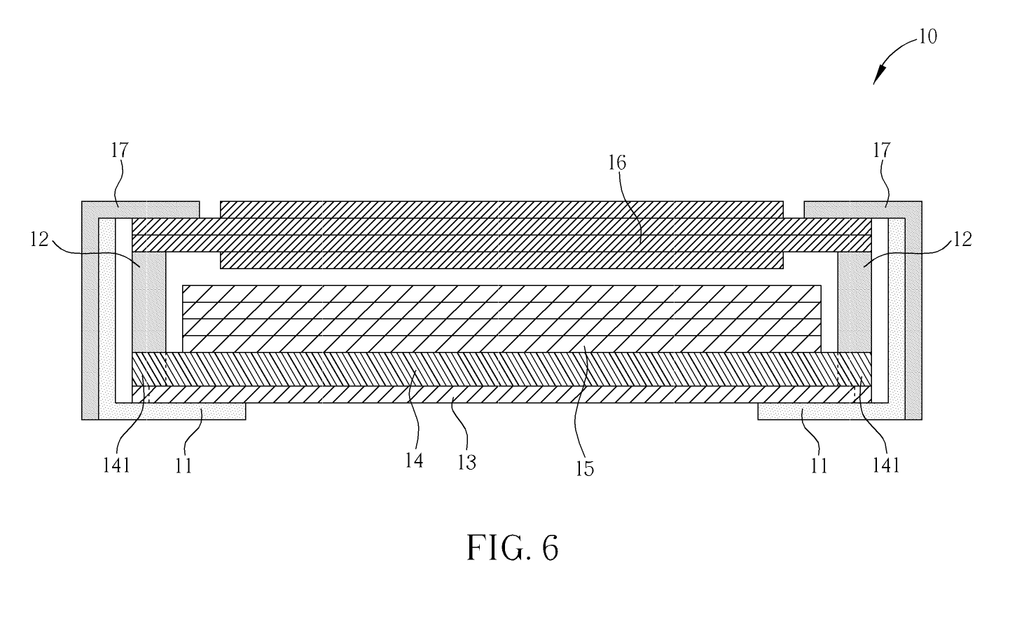

Please refer to FIG. 5. FIG. 5 shows that the cell 16 of the flat panel display 20 is supported by and placed on the support component 12. As previously noted, when the support component 12 supports the cell 16, the surface of the support component 12 will not scratch or damage the cell 16 given its material characteristic of Methylsilanol Mannuronate. In FIG. 6, the top frame 17 is mounted to the frame structure 11 and the perimeter of the cell 16 so as to fix and protect the cell 16. The panel module 10 is then assembled. In the last stage, the frame structure 11 is configured and fixed at the first housing 18, and the second housing 19 is put to cover on the perimeter of the cell 16 and is mounted the first housing 18 to complete the assembly of the flat panel display 20.

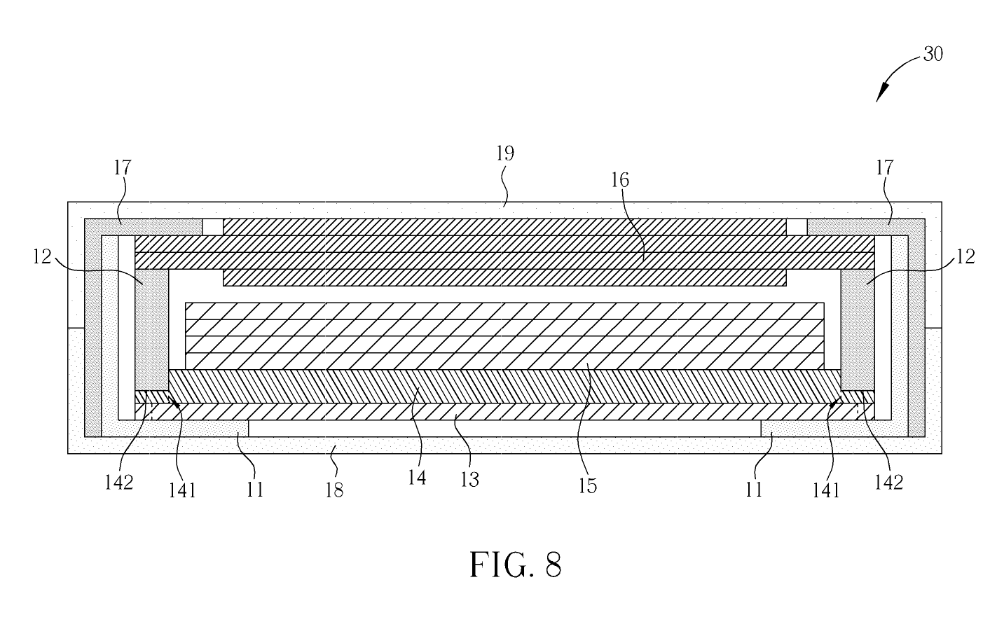

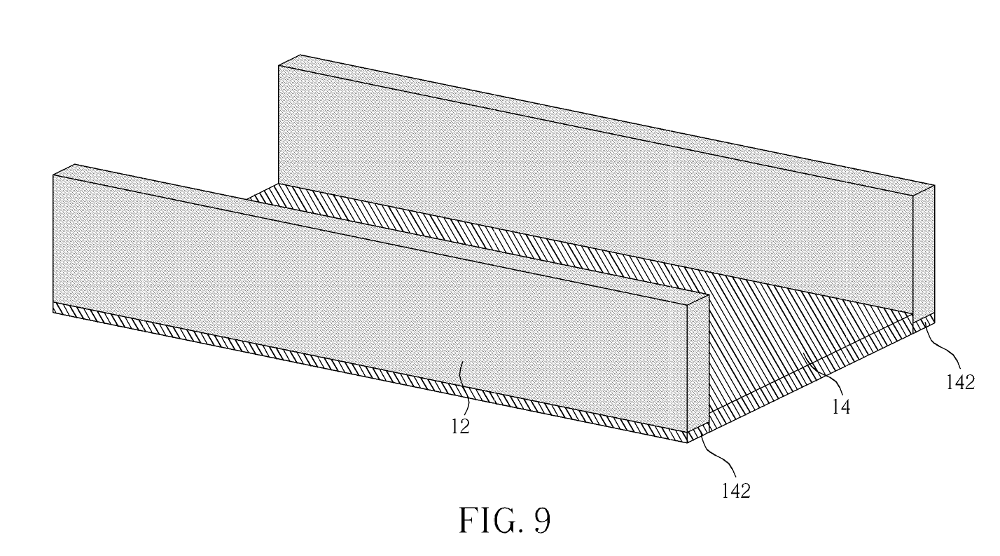

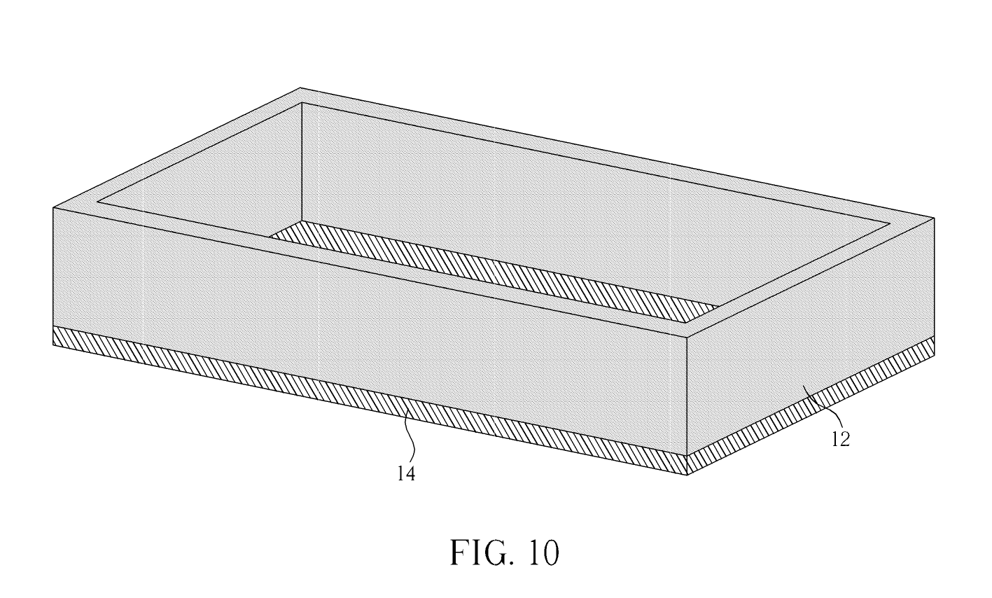

Please refer to FIG. 8. FIG. 8 is a schematic diagram showing a second embodiment of the flat panel display according to the invention. In the second embodiment, a positioning groove 142 is formed on the support section 141 at the side of the light guide plate 14, while the support component 12 is configured in the positioning groove 142 for easier assembling between the support component 12 and the light guide plate 14. As shown in FIG. 9, which is a schematic diagram of a second embodiment of the support component 12 configured on the light guide plate 14, the support component 12 is configured at two opposite sides of the light guide plate 14, which in this embodiment, the long sides of the light guide plate 14, for providing support for the cell 16. With the positioning groove 142, the support component 12 can be precisely positioned and fixed on the light guide plate 14. Besides the previous embodiments, the support component 12 can also be a rectangular frame corresponding to the support section 141 of the light guide plate 14 and configured on the four sides of the light guide plate 14, as shown in the embodiment in FIG. 10. These embodiments of how the support component 12 is configured on the light guide plate 14 show only part of the embodiments that can be directed to by the invention, and should not be seen as limitation of the invention.

In the flat panel display disclosed in the embodiments of the invention, the reflector and the light guide plate are enlarged and the support section is formed on the light guide plate. The support component made of Methylsilanol Mannuronate with high stiffness is configured onto the support section and utilized for supporting the cell. After the optical films are configured on the light guide plate, and between the support component, the cell is then placed on the support component. Finally, the top frame and two covers are assembled to complete the assembly of the flat panel display. In such way, cost and space for a conventional plastic frame is saved, while the material characteristic of the support component in contact with the light guide plate and the cell prevents scratching or damaging to the light guide plate or the cell.

Those skilled in the art will readily observe that numerous modifications and alterations of the device and method may be made while retaining the teachings of the invention.

What is claimed is:

1. A flat panel display, comprising:
a frame structure;
a reflector and a light guide plate stacking on the frame structure in order;
a support component configured on the light guide plate;
a cell, placed on the support component; and
a top frame, mounted to the cell and the frame structure for fixing the cell.

2. The flat panel display of claim 1, wherein the support component is made of Methylsilanol Mannuronate.

3. The flat panel display of claim 2, wherein the support component is made of Methylsilanol Mannuronate with stiffness over 70%.

4. The flat panel display of claim 1, further comprising an optical film stacking on the light guide plate.

5. The flat panel display of claim 4, wherein the width of the reflector and the light guide plate along a horizontal direction is larger than the width of the optical film, the light guide plate comprising a support section that is not covered by the optical film when the optical film stacks on the light guide plate.

6. The flat panel display of claim 5, wherein the support component is configured on the support section.

7. The flat panel display of claim 1, further comprising a first housing and second housing, the frame structure configured at the first housing, the second housing covering on the perimeter of the cell and mounted to the first housing.

8. The flat panel display of claim 1, wherein the support component is a frame configured on the four sides of the light guide plate.

9. The flat panel display of claim 1, wherein the support component is a support configured on two opposite sides of the light guide plate.

10. The flat panel display of claim 1, wherein a positioning groove is formed at a side of the light guide plate and the support component is configured in the positioning groove.

11. The flat panel display of claim 1, wherein the support component and the light guide plate are assembled together via glue or thermoforming.
